(19) United States
(12) Patent Application Publication
(10) Pub. No.: US 2018/0048954 A1
(43) Pub. Date: Feb. 15, 2018

(54) Detection of movement adjacent an earpiece device

(71) Applicant: BRAGI GmbH, München (DE)

(72) Inventors: Friedrich Christian Förstner, München (DE); Martin Steiner, München (DE); Engin Çagatay, München (DE); Nikolaj Hviid, München (DE); Peter Vincent Boesen, München (DE)

(73) Assignee: BRAGI GmbH, München (DE)

(21) Appl. No.: 15/674,770

(22) Filed: Aug. 11, 2017

Related U.S. Application Data
(60) Provisional application No. 62/375,337, filed on Aug. 15, 2016.

(51) Int. Cl. H04R 1/10

(52) U.S. Cl. CPC H04R 1/1041; H04R 1/1016; H04R 2420/07

(57) ABSTRACT

An earpiece includes an earpiece housing, a processor disposed within the housing and a sensor system associated with the earpiece housing, the sensor system operatively connected to the processor. The sensor system is configured to detect skin touches proximate the earpiece housing. The sensor system may include an emitter and a detector which may be a light emitters/light detectors or other types of emitters and detectors. The skin touches may be skin touches on an ear of the housing while the earpiece is positioned within the ear. The earpiece may further include a speaker and wherein the earpiece provides audio feedback through the speaker in response to the skin touches.

### PRIORITY STATEMENT

This application claims priority to U.S. Provisional Patent Application 62/375,337, filed on Aug. 15, 2016, and entitled Detection of movement adjacent an earpiece device, hereby incorporated by reference in its entirety.

### FIELD OF THE INVENTION

The present invention relates to wearable devices. More particularly, but not exclusively, the present invention relates to ear pieces.

### BACKGROUND

Natural and user friendly interfaces are desirable, particularly for wearable devices. What is needed are new and improved apparatus, methods, and systems for wearable devices which allow for natural and user friendly interactions.

### SUMMARY

Therefore, it is a primary object, feature, or advantage of the present invention to improve over the state of the art.

It is a further object, feature, or advantage of the present invention to provide a wearable device that captures skin touches.

It is a still further object, feature, or advantage of the present invention to use skin touches to provide user input.

Another object, feature, or advantage is to monitor and classify skin touches.

Yet another object, feature, or advantage is to provide greater accuracy and reliability of input modality

A still further object, feature, or advantage is to provide greater range of options for movements, gestures including three dimensional or complex movement.

Another object, feature, or advantage is to provide a user interface for a wearable device that permits a wider area of input than a wearable device surface.

Yet another object, feature, or advantage is to provide a user interface for a wearable device that provides for multi-touch input.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to one aspect, an earpiece includes an earpiece housing, a processor disposed within the housing and a sensor system associated with the earpiece housing, the sensor system operatively connected to the processor. The sensor system is configured to detect skin touches proximate the earpiece housing. The sensor system may include an emitter and a detector which may be a light emitters/light detectors or other types of emitters and detectors. The skin touches may be skin touches on an ear of the housing while the earpiece is positioned within the ear. The earpiece may further include a speaker and wherein the earpiece provides audio feedback through the speaker in response to the skin touches. Alternatively, feedback may be otherwise provided such as thermal feedback or other type of feedback. The processor provides for interpreting the skin touches. The skin touches may be interpreted as indicative of an emotion, as indicative of a medical condition, or as a command. The skin touches may be performed by a person other than a user wearing the earpiece. The skin touches may be associated with physiological measurements. In addition, the sensor system is further configured to detect gestures proximate the earpiece housing, the gestures not touching skin.

According to another aspect, a method for receiving user input at an earpiece is provided. The method may include emitting energy from the earpiece, detecting reflections of the energy at the earpiece, analyzing the reflections to determine the reflection are indicative of a skin touch, and using the skin touch to provide the user input at the earpiece. The skin touch may be a touch of an ear of a user of the earpiece. The method may further include classifying the skin touch as a type of skin touch.

### BRIEF DESCRIPTION OF THE DRAWINGS

FIG. 1 illustrates a set of earpieces with a touch based interface.

FIG. 2 is a block diagram illustrating a wearable device with a touch based interface.

FIG. 3 is a block diagram illustrating a wearable device with an IR LED touch based interface.

FIG. 4 is a block diagram illustrating a wearable device with an ultrasound touch based interface.

FIG. 5 is a block diagram illustrating a wearable device with a radar touch based interface.

FIG. 6 illustrates an example of providing skin touch input to an earpiece.

FIG. 7 illustrates an example of providing skin touch input.

FIG. 8 illustrates another example of providing skin touch input.

FIG. 9 illustrates a mobile app in communication with wearable devices having gesture based interfaces.

### DETAILED DESCRIPTION

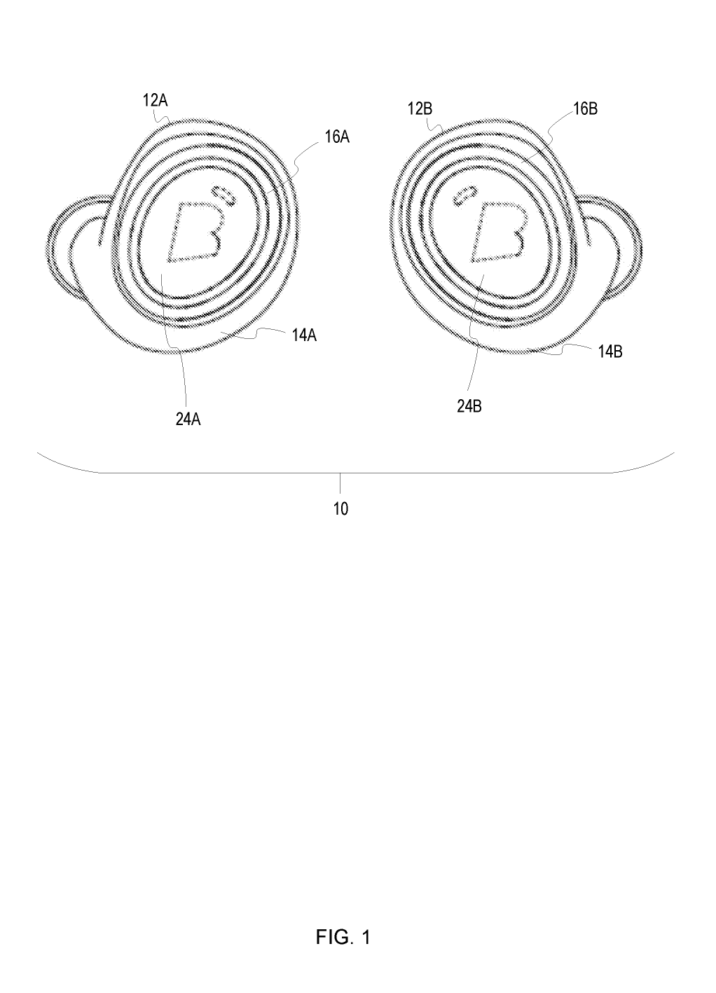

The present invention relates to using wearable devices to sense touch such as the touching of the skin of the human body. FIG. 1 illustrates one example. As shown in FIG. 1, the wearable device is an earpiece. The earpiece includes one or more sensors configured to sense when the individual touches the skin or other area proximate to or within range of the earpiece.

Various types of sensors may be used. Generally, a set of emitters and detectors may be used in order to determine a change in a field associated with a touch. In one embodiment, infrared LEDs may be used. According to one aspect, touching on the skin proximate to an earpiece may provide for providing user input to the earpiece such as taps, double taps, triple taps, holds, and swipes of various directionalities. This may be advantageous over touching the earpiece itself which may affect the fit of the earpiece to the ear or possibly create minor discomfort and limit the area within which the input is received. In addition, it may be more natural and intuitive to an individual to touch their skin as opposed to the earpiece. There are numerous other advantages. For example, the area being touched may be expanded beyond the relatively small area available on an earpiece. Thus, more types of movements or touches may be detected. This may include multi-touches such as multi-touches with multiple fingers. The movements may include pinches, taps, drifts, soft touches, strokes, chordic touches (multiple fingers in a particular sequence), and other types of touches.

Because the skin or body may be touched, more natural types of touches may be performed. This may also include multiple hands, especially where there are sensors on more than one wearable device, such as with left and right earpieces. This also may include gestures close to but not touching the skin. For example, one or more hands may be shaken. One or more hands may hide all or a portion of the face, one or more hands may move side to side, up and down, rotate, or any number of other hand and/finger movement combinations. Because of the natural use of hands for expression, a more natural user interface may be provided to communicate with the device.

In addition, these various hand or finger movements may be sensed not only for directly communicating with the device, but also for the wearable device to gain insight into actions or even emotions of a user. For example, a person rubbing their eyes, putting their hand in their mouth or ear, or nose may be indicative of a medical condition or medical need. The wearable device may sense and characterize these movements so that the device may take appropriate actions such as providing audio feedback to the user or storing the data for later reporting. These characterizations may be performed in any number of ways. For example, these characterizations may be performed by a statistical analysis of the movements, the characterizations may be based on comparisons of the movements to movements within a library of movements and their characterizations. The library may be built based on a number of different users, or may be built based on a training mode in which the user confirms the characterization of different movements. Of course, any number of other analyses or models may be used including those using fuzzy logic, genetic algorithms, neural networks, or other types of analysis.

The sensors may be placed in any number of positions on the body or on peripherals. This may include being placed on earpieces, articles of clothing, articles of jewelry, or otherwise. The sensors may be used to not only detect skin touch of the user but also skin touch between another individual of the user such as may occur during a handshake, a hug, a kiss, an intimate encounter or otherwise. Information from the sensors sensing skin touch may be combined with other information to provide additional user context including through information from image sensors, microphones, physiological sensors, or other types of sensors. For example, changes in impedance may be measured to assist in identifying an individual.

FIG. 1 illustrates one example of a wearable device in the form of a set of earpieces 10 including a left ear piece 12A and a right earpiece 12B. Each of the ear pieces 12A, 12B has an ear piece housing 14A, 14B which may be in the form of a protective shell or casing. A light display area 16A, 16B is present on each of the ear pieces 12A, 12B. The light generation areas 16A, 16B each provide for producing light of one or more colors.

The wearable device may be used to sense touches of the user within an area in proximity or range of the wearable device. One or more detectors or receivers 24A, 24B may also be present to detect changes in energy fields associated with gestures performed by a user. The receivers 24A, 24B in combination with one or more emitters provide a gesture based user interface.

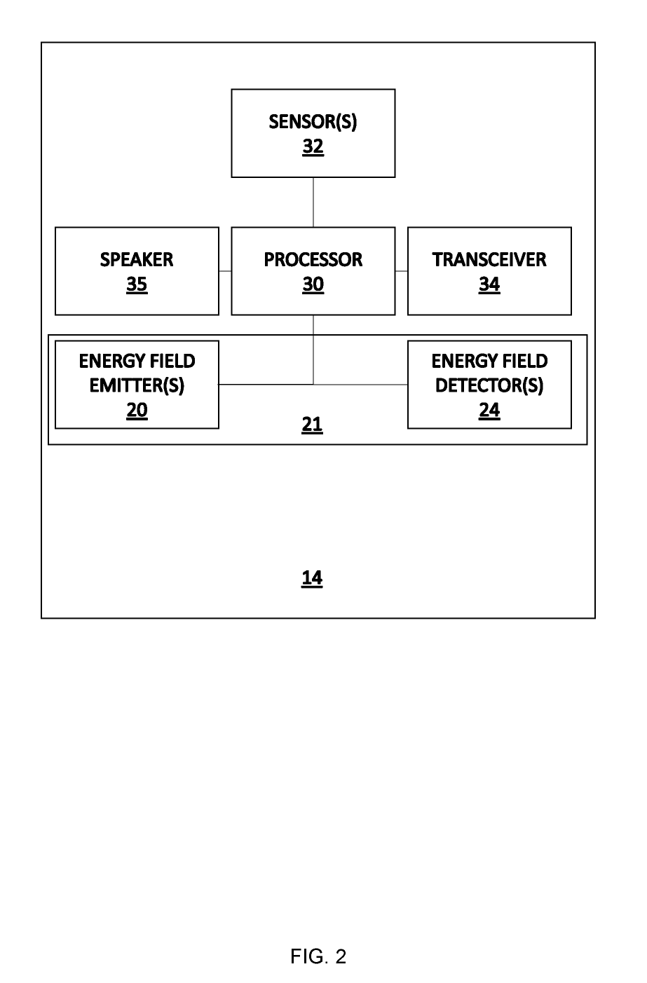

FIG. 2 is a block diagram illustrating a device with a housing 14. The device may include a touch based user interface including one or more energy field emitters and one or more energy field detectors. One or more energy field emitters 20 (such as IR LEDs, other type of light emitters, ultrasound emitters, or other types of sound emitters, or other energy field emitters) may be used. The energy field emitters are operatively connected to the processor 30. It should be understood that interconnecting logic and circuits is not shown. It is to be further understood that the processor shown may include a plurality of different processors or additional circuitry. The processor 30 may also be operatively connected to one or more energy field detectors 24. The energy field detectors may be optical detectors, light detectors, sound detectors or other types of detectors or receivers and not capacitive sensors. For example, wherein the energy field emitters 20 are IR LEDs, the energy field detectors 24 may be IR receivers. The processor 30 may also be electrically connected to one or more sensors 32 (such as, but not limited to an inertial sensor, one or more contact sensors, a bone conduction sensor, one or more microphones, a pulse oximeter, or other biological sensors) and a transceiver 34 such as a short range transceiver using Bluetooth, UWB, magnetic induction, or other means of communication.

The processor 30 may also be operatively connected to one or more speakers 35. In operation, the processor 30 may be programed to receive different information using a touch-based user interface including the energy field emitter(s) 20 and the energy field detector(s) 24

The wearable device may be a wireless earpiece designed to fit into the external ear and concha cavum segment of the pinna. The system may be responsive in a number of harsh environments. These vary from complete submersion in water to being able to be accessed while wearing gloves, among others.

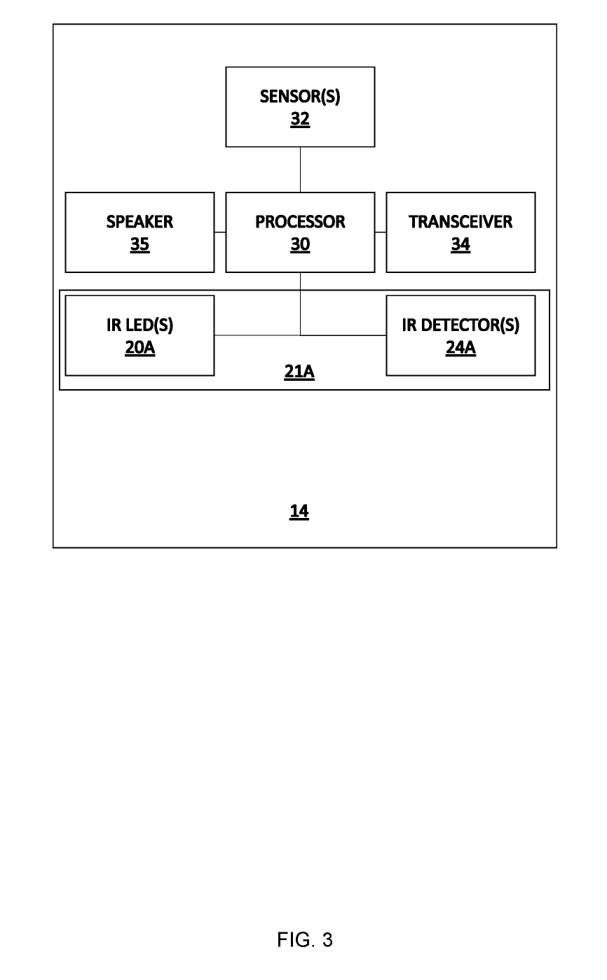

As shown in FIG. 3, one embodiment utilizes an optical sensor chip as the detector 24A with associated LEDs 20A as a part of an IR LED interface 21A. These LEDs 20A are spatially segregated. The LEDs 20A are designed so that the user reflects some of the emitted light back to the sensor. If the user gets near the range of the IR, then an action is triggered. In order to allow for precise identification of signal vs. artifact, the preferred embodiment sets the IR emission at a slow rate, e.g. 100 ms intervals. When an object comes within the range of the light emitted, this then triggers an algorithm control for proximity detection. If an object is within the proximity of the one or more LED emitters, the algorithm directs the IR LED emitters to adopt a high sample rate e.g. 4 ms intervals. Reflection patterns can then be read correctly identified as touches. More than one LED emitter may be used to allow for more sophisticated touch interactions. Greater numbers, intensities, and placements of the LED emitters may be used to increase the area where touch may be sensed.

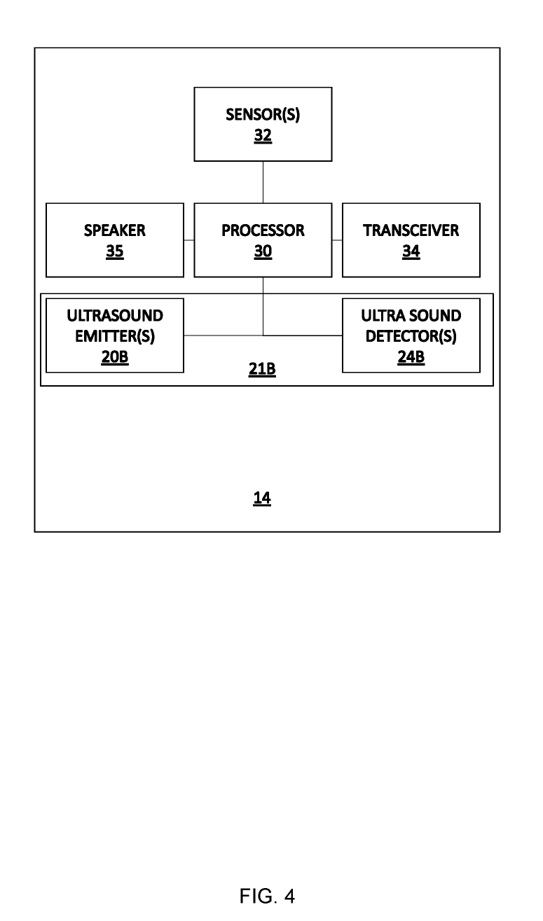

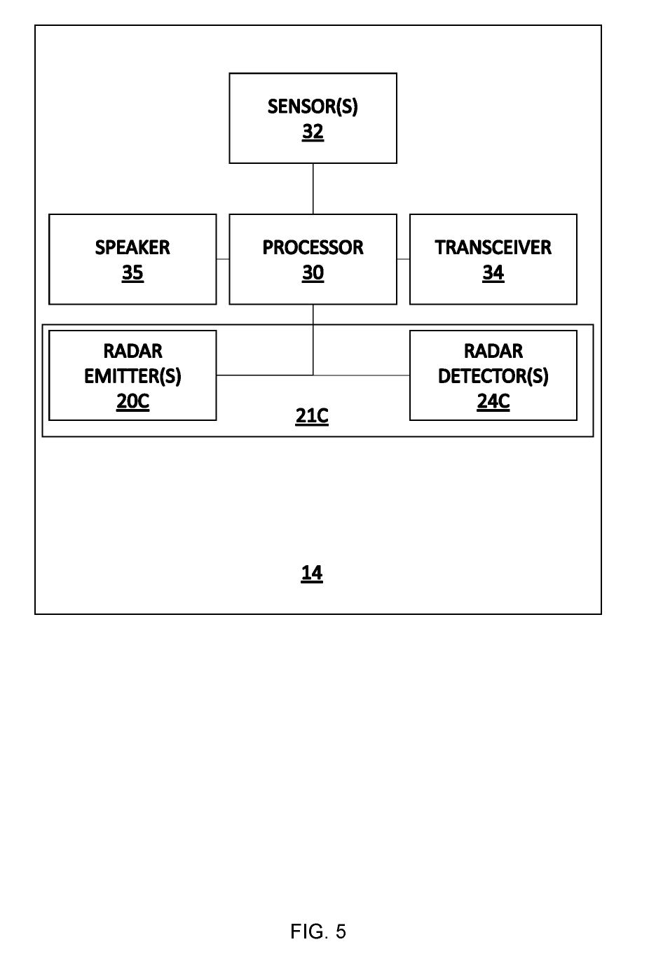

In operation, a user may wear the ear piece. The user may touch the skin near the IR LED interface (or other type of interface). The touch may be in the form of a tap, a double tap, a triple tap, a swipe (such as a swipe with a particular directionality), a hold, or other type of touch. Note that different functionalities may be associated with different type of touches and different functionalities may be associated with the same touch when the device is operating in different modes of operation or based on the presence or absence of other contextual information. Other types of technology may be used including ultrasound emitters 20B and ultrasound detectors 24B in the touch interface 21B of FIG. 4 or radar emitters 20C and radar detectors 24C in the touch interface 21C of FIG. 5.

It is also contemplated that more than one wearable device may be used. For example, two earpieces may be used each with its own user interface. Where multiple devices are used, it is to be understood that the same gesture performed at one device may be associated with one function while the same gesture performed at the other device may associated with a different function. Alternatively, the same gesture may perform the same function regardless of which device the gesture is performed at.

It is further contemplated that haptic or audio feedback or a combination thereof may be provided to the user in response to touches made. For example, the haptic, the haptic thermal, or audio feedback may simply indicate that the touch was received or may specify the functionality associated with the touch. Alternatively, the audio feedback may request further input in the form of touches or otherwise. Alternatively, still, the audio feedback may offer a suggestion based on an interpretation of the touches such as where the touches are indicative of an emotion or physical condition, or otherwise. The haptic feedback may be in the form of pressure, heat, cold, or other sensation.

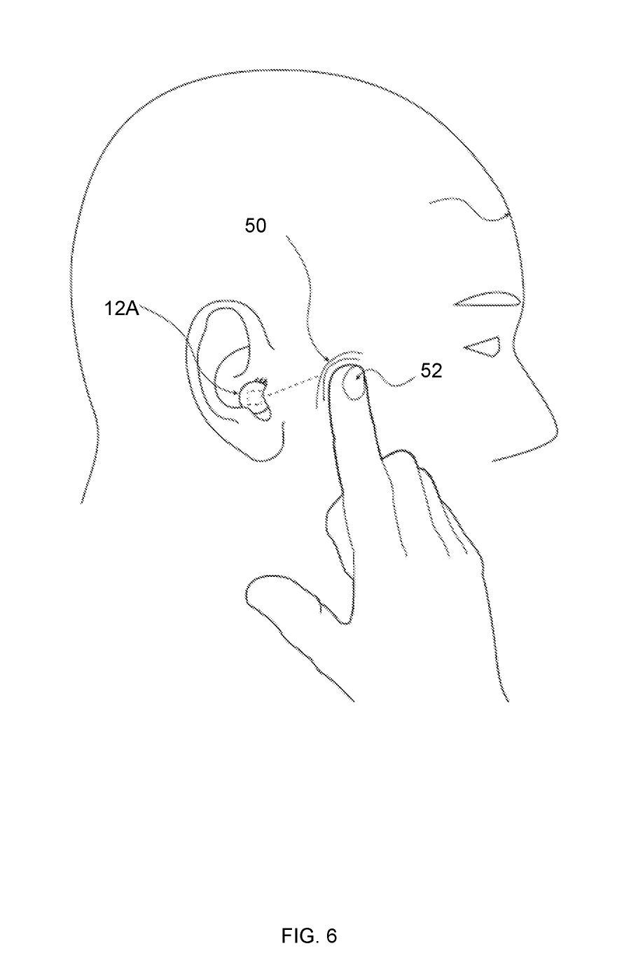

As shown in FIG. 6, a user is wearing an earpiece 12A equipped with a sensor system for detecting touch. A user may use their finger 52 to touch an area 50 proximate the earpiece 12A. It is also contemplated that the skin surface being used may be remote from where the wearable device is worn. For example, a user may lift their hand near the earpiece and use fingers on the other hand to make motions which provide input. Thus, remote sensors may be used. The user may touch any number of different areas proximate to the wearable device. For example, where the wearable device is an earpiece 12A, the user may touch different areas on the ear. Thus, for example, stroking the posterior helical rim in an up or down fashion may be used to control volume of the earpiece or other functions. Touching the superior helical rim could advance a song forward or perform other functions. Squeezing the lobule with a thumb and pointing finger, for example, could pause or stop the current function among other actions.

Movement may be able to augment physiological sensing. Thus, for example, placing a finger anterior to the tragus would allow sensor capture of heart rate by monitoring finger movement or other movement. Another example, is that skin temperature may be determined from a finger placed near the wearable device.

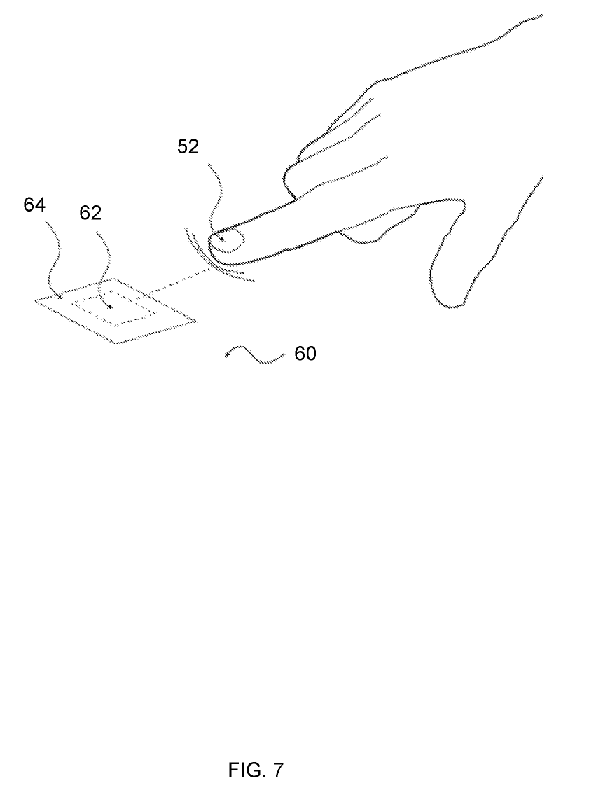

As shown in FIG. 7, in a system 60, a user may touch their finger 52 at or near a wearable device 64 having a sensor system 62.

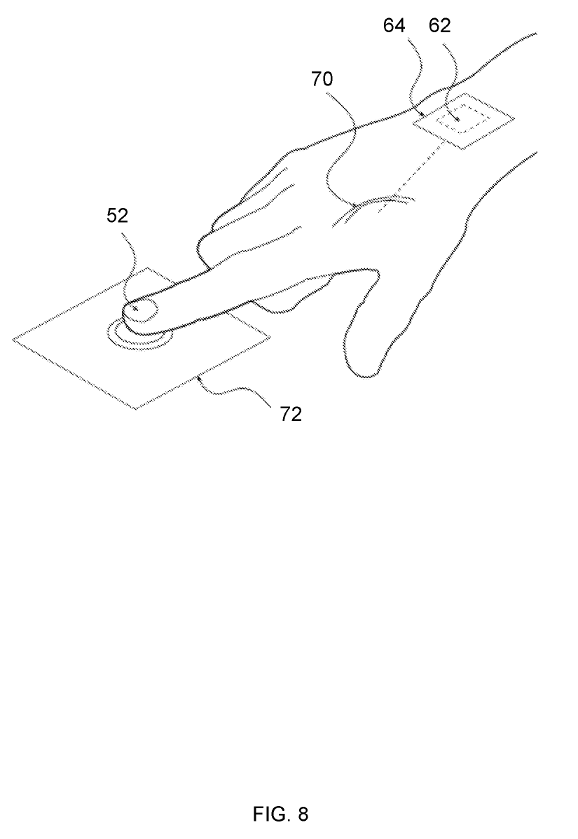

As shown in FIG. 8, more than one sensor may be present. For example, a wearable device 64 with a sensor system 62 may be present on a wrist of a user such as in a watch of the user, a ring or other jewelry item, article of clothing, or other wearable. Movement of a portion of a hand 70 or finger 52 may be detected. Data detected with the wearable device 64 may be combined with data detected from other sensors such as those associated with a device 72 which is touched with a finger 52.

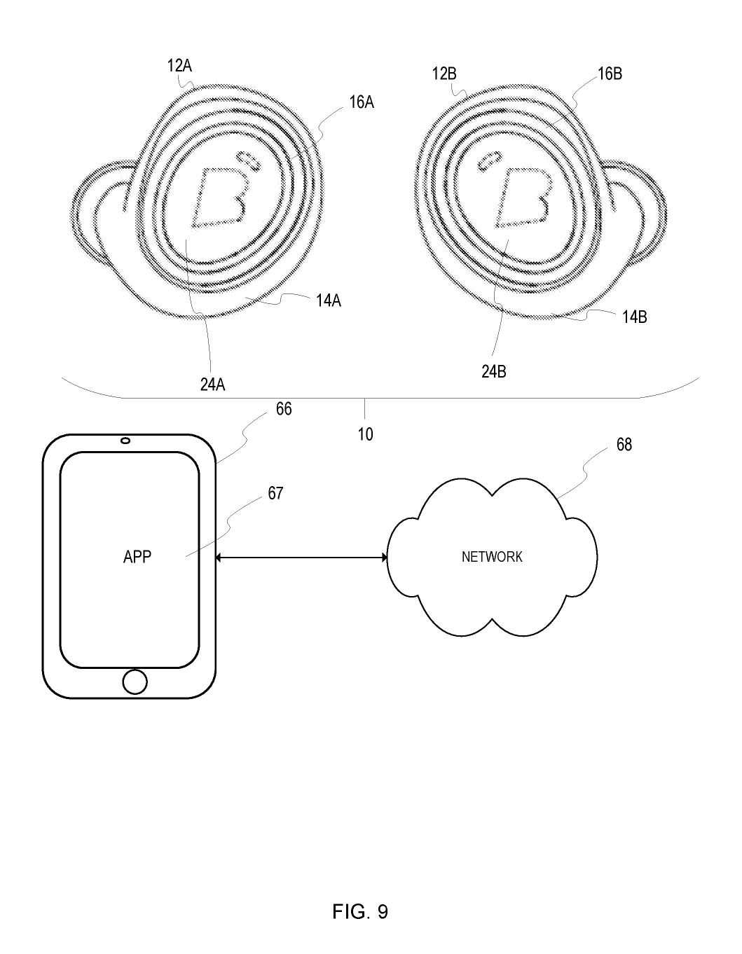

As shown in FIG. 9, user settings may be changed through the device or through other devices in operative communication with the device such as through a mobile application 67 operating on a mobile device 66 in wireless communication with one or more wearable devices 12A, 12B, each having a touch-based user interface.

Therefore, various apparatus, systems, and methods have been shown and described. Differences in the type of energy detection, the algorithms used, the gestures used, and other options, variations, and alternatives are contemplated.

What is claimed is:

1. An earpiece comprising:
an earpiece housing;
a processor disposed within the housing;
a sensor system associated with the earpiece housing, the sensor system operatively connected to the processor;
wherein the sensor system is configured to detect skin touches proximate the earpiece housing.

2. The earpiece of claim 1 wherein the sensor system comprises an emitter and a detector.

3. The earpiece of claim 2 wherein the skin touches are skin touches on an ear of the of a user while the earpiece is positioned within the ear.

4. The earpiece of claim 1 wherein the earpiece comprise a speaker and wherein the earpiece provides audio feedback through the speaker in response to the skin touches.

5. The earpiece of claim 1 wherein the processor provides for interpreting the skin touches.

6. The earpiece of claim 5 wherein the processor interprets the skin touches as indicative of an emotion.

7. The earpiece of claim 5 wherein the processor interprets the skin touches as indicative of a medical condition.

8. The earpiece of claim 1 wherein the skin touches are by a person other than a user of the earpiece.

9. The earpiece of claim 1 wherein the skin touches are associated with physiological measurement.

10. The earpiece of claim 1 wherein the sensor system is further configured to detect gestures proximate the earpiece housing, the gestures not touching skin.

11. A method for receiving user input at an earpiece, the method comprising:
emitting energy from the earpiece;
detecting reflections of the energy at the earpiece;
analyzing the reflections to determine the reflection are indicative of a skin touch;
using the skin touch to provide the user input at the earpiece.

12. The method of claim 11 wherein the skin touch is a touch of an ear of a user of the earpiece.

13. The method of claim 11 further comprising classifying the skin touch as a type of skin touch.

14. An earpiece comprising:
an earpiece housing;
a processor disposed within the housing;
an optical emitter operatively connected to the processor;
an optical detector operatively connected to the processor;
wherein the optical emitter and the optical detector are positioned to detect skin touches made by a person, the skin touches proximate to the earpiece housing.

15. The earpiece of claim 14 wherein the earpiece comprise a speaker and wherein the earpiece provides audio feedback through the speaker in response to the skin touches.

16. The earpiece of claim 14 wherein the processor provides for interpreting the skin touches.

17. The earpiece of claim 16 wherein the processor interprets the skin touches as indicative of an emotion.

18. The earpiece of claim 16 wherein the processor interprets the skin touches as indicative of a medical condition.

19. The earpiece of claim 14 wherein the person is not a user of the earpiece.

20. The earpiece of claim 14 wherein the skin touches are associated with physiological measurement.
